(19) United States
(12) Patent Application Publication
(10) Pub. No.: US 2020/0232794 A1
(43) Pub. Date: Jul. 23, 2020

(54) Drone for Measuring Water Depth of Field

(71) Applicant: NILEWORKS, Tokyo (JP)

(72) Inventor: Hiroshi YANAGISHITA, Tokyo (JP)

(21) Appl. No.: 16/492,840

(22) PCT Filed: Jun. 3, 2018
(86) PCT No.: PCT/JP2018/008490

§ 371 Date: Apr. 3, 2020

(30) Foreign Application Priority Data
Mar. 12, 2017 (JP) 2017-046845

(51) Int. Cl. G01C 13/00; G01C 9/00; G01C 25/00; B64C 39/02

(52) U.S. Cl. CPC G01C 13/008; G01C 9/005; B64C 2201/12; B64C 39/024; B64C 2201/027; G01C 25/005

(57) ABSTRACT

The present invention provides a simple method and apparatus capable of accurately measuring the water depth of a field, in particular, the whole field.

SOLUTION: An ultrasonic transmitter/receiver and a drone equipped with an infrared transmitter/receiver or a microwave transmitter/receiver are allowed to fly over the field, and the distance between the ultrasonic wave surface reflection and the microwave or infrared ground reflection. Measure the water depth just below the drone from the difference in measurement. By flying the drone all over the field, the water depth of the entire field can be accurately measured. The measurement is preferably performed only while the drone is flying at a predetermined speed or higher.

### TECHNICAL FIELD

The present invention relates to a drone for measuring the water depth of a field using an unmanned air vehicle (drone).

### BACKGROUND ART

Maintaining the water level in the field is extremely important in the cultivation of rice and other crops. For example, when spraying the herbicide, it takes about one week until an appropriate treatment layer is formed, but if the ground is exposed from the water surface even partially during that time, the treatment layer is not well formed, the herbicide will not be effective. In order to prevent such a situation, it is indispensable to manage the water level in the entire field.

One of common methods of measuring the water depth in the field is to use a depth meter installed in the field. However, because the height of the field ground is not even, the water depth measured by one depth meter is inappropriate for representing the water depth for the entire field. A method of using a large number of depth meter in one field is known (for example, Patent Document 1), but there are problems in terms of cost and management workload.

### PRIOR ART DOCUMENTS

### Patent Document

[Patent Document 1] Japanese Patent Publication No. 09-20908

### SUMMARY OF THE INVENTION

### Problems to be Solved by the Invention

To provided is a simple apparatus capable of accurately measuring the water depth of a whole farm field, particularly a rice field.

### Means for Solving the Problems

The present invention solves the above problems by providing an unmanned aerial vehicle comprising: a first sensor that measures the distance to the surface of the water; and a second sensor that measures the distance to the ground; the unmanned aerial vehicle taking the difference between the two distances and calculating a water depth at a point directly below the unmanned aerial vehicle.

Further, the present invention solves the above problems by providing the unmanned aerial vehicle according to the paragraph 0006, further comprising control means for measuring a water depth at a point immediately below the aircraft only during flight at a predetermined speed or higher.

Further, the present invention solves the above problems by providing the unmanned aerial vehicle according to the paragraph 0006, further comprising a tilt sensor, and means for calibrating a distance measured according to the tilt of the unmanned aerial vehicle.

Further, the present invention solves the above problems by providing the unmanned aerial vehicle according to the paragraph 0006, wherein the first sensor is an ultrasonic transceiver, and the second sensor is an infrared transceiver or a microwave transceiver.

### Advantageous Effect of the Invention

A simple apparatus capable of accurately measuring the water depth of a whole farm field, particularly a rice field is provided.

### BRIEF DESCRIPTION OF THE DRAWING

FIG. 1 This is an overall view (plan view and front view) of an embodiment of a field water depth measurement drone according to the present invention.

FIG. 2 This is a diagram showing a basic concept of a field water depth measurement method according to the present invention.

FIG. 3 This is a diagram explaining elimination of the influence of a rotor blade wind in a field water depth measurement drone according to the present invention.

### DESCRIPTION OF EMBODIMENTS

Hereinafter, embodiments of the present invention will be described with reference to the figures. All figures are exemplary.

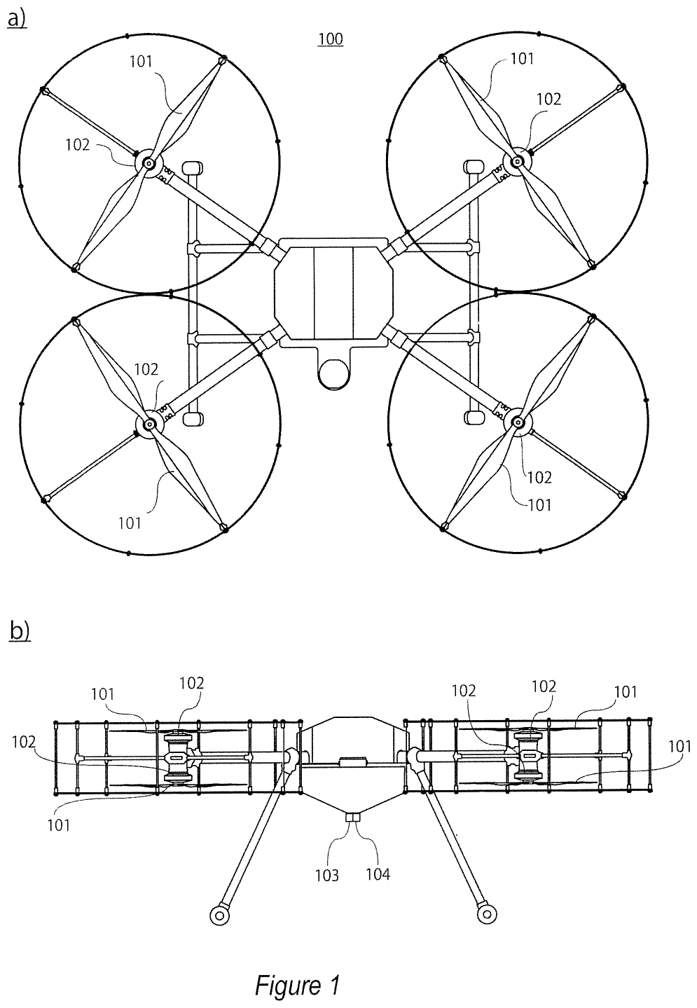

FIG. 1 shows the overall structure of a drone (100) according to the present invention (FIG. 1a is a plan view and FIG. 1b is a front view). In the present specification, “drone” refers to any kinds of unmanned aerial vehicles regardless of a driving method or a control method. The rotor (101) and the motor (102) are means to fly the drone. In the FIG. 1, a configuration using four sets of two-stage rotors is shown, but the number of rotors and the configuration may be different. A drone (100) according to the present invention preferably includes a computer device and programs for controlling flight, and calculating and storing the water depth; wireless communication means for a remote control; a GPS device for position detection; and a battery, but these elements are not shown in the figure. Elements necessary for drones in general, such as legs for landing, a frame for holding the motors, and a safety frame for preventing the hands from touching the rotor blades are illustrated, but will not be explained further, since they are obvious. Note that the drone (100) according to the present invention preferably includes a device such as RTK-GPS that can accurately measure the position of itself.

An ultrasonic transceiver (103) and an infrared transceiver (104) are provided in the lower part of the drone (100) according to the present invention. The ultrasonic transceiver (103) is an example of means for measuring the distance to the water surface, and the infrared transceiver (104) is an example of means for measuring the distance to the ground below the water surface. A microwave transceiver or the like may be used instead of the infrared transceiver (104). The ultrasonic transceiver (103) preferably uses a sensor using a frequency of about 400 kHz (or a frequency of at least 100 kHz) for accurate measurement for a short distance. The infrared transceiver (104) uses near infrared rays having a wavelength of several micrometers, and preferably uses a laser in order to minimize attenuation.

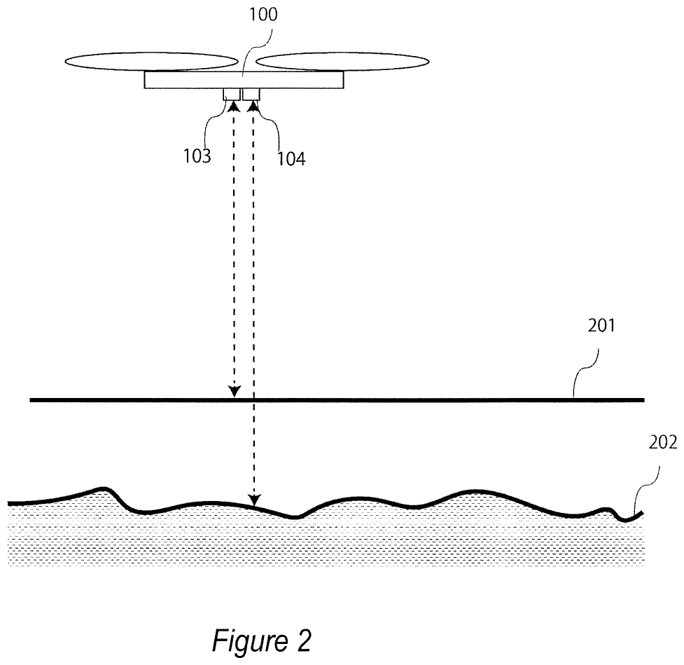

FIG. 2 shows the basic concept of the field water depth measurement method according to the present invention. Since the ultrasonic waves generated by the ultrasonic transceiver (103) are mainly reflected on the water surface (201), the distance from the drone (100) to the water surface can be measured based on the phase difference of the reflected waves. By using an ultrasonic transceiver (103) that is generally available at the time of the filing, measurement with about one centimeter precision is possible. Since the speed of sound changes depending on the temperature, the air speed may be calibrated by providing the drone (100) with a temperature sensor or the like to measure the air temperature.

On the other hand, most of the infrared laser light generated by the infrared transceiver (104) penetrates the water and is reflected by the ground (202) in the field. By measuring the phase difference of the reflected wave from the ground, the distance from the drone (100) to the ground of the field can be measured.

By calculating the difference between the distance between the drone (100) and the water surface obtained by the ultrasonic receiver (103) and the distance between the drone (100) and the ground obtained by the infrared transceiver (104), the depth of water in the field directly below the drone (100) can be measured with a precision of about 1 centimeter, as proven by the inventor's experiments.

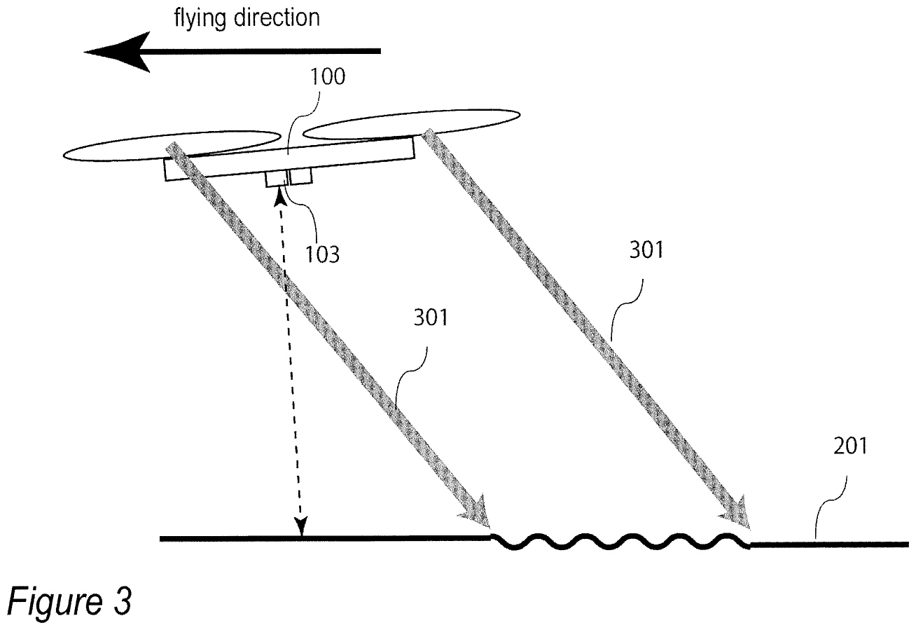

FIG. 3 explains how the measurement of the water depth by the field water depth measurement drone (100) according to the present invention can eliminate the influence of the wind of the rotor blades (101). In general, a drone is lifted and moved forward by a downward airflow generated by rotor blades. Therefore, it is necessary to eliminate the influence of the airflow to the water surface. When the drone (100) is moving at a normal flight speed (typically 5 meters per second), the turbulence of the water surface (201) due to the airflow (301) of the rotor blades occurs behind the drone (opposite the direction of the travel), not at the point directly below the drone. The measurement of the distance to the water surface by the ultrasonic transceiver (103) is performed directly below the drone (100) body, and thus is not affected by the disturbance of the water surface. For example, under a typical condition where a drone (100) with a rotor radius of 70 centimeters flies at an altitude of 3 meters from the water surface at a speed of 5 meters per second, the measurement of the distance to the surface is not affected by turbulence in the surface, as proven by experiments by the inventors. For this reason, the control should be provided such that the depth measurement according to the present invention is performed only when the drone (100) is flying at a steady speed (for example, about 5 meters per second), and not performed when the drone is hovering or flying at a low speed (for example, about 3 meters or less per second). Since the drone (100) moves forward by increasing the rotational speed of the rotor blades behind the traveling direction compared the rotational speed of the rotor blades ahead of the traveling direction, the frontside of the drone becomes lower during the flight. Therefore, the drone (100) according to the present invention preferably is provided with means for measuring the inclination (tilt) of the airframe such as a gyro sensor, and the values measured by the ultrasonic transceiver (103) and the infrared transceiver (104) preferably are calibrated in the computer program for measuring and storing the distances.

By using the drone (100) equipped with accurate position measurement devices such as RTK-GPS, it is possible to control the drone (100) to fly over the entire field. Therefore, the water depth of the entire field can be easily measured by the water depth measurement drone (100) according to the present invention. Concurrently with the water depth measurement, operations such as pesticide spraying and crop photography in the field may be performed. It is preferable to store the measured water depth information of the entire field in the memory equipped in the drone (100) main body or in a device connected to the drone (100) and later use it to improve the water depth management tasks.

### Technologically Significant Advantageous Effect of the Present Invention

With the present invention, the depth of water in the entire field can be measured efficiently and accurately without using a large number of depth meters. In addition, in the depth measurement, it is possible to minimize the influence of the airflow caused by the drone rotor blades.

1. An unmanned aerial vehicle comprising:
a first sensor that measures a first distance to a water surface;
a second sensor that measures a second distance to a ground; and
a controller that calculates a difference between the first distance and the second distance to measure a water depth at a point directly below the unmanned aerial vehicle.

2. An unmanned aerial vehicle according to claim 1, wherein the controller measures a water depth at a point immediately below the aircraft during a flight at a predetermined speed or higher.

3. An unmanned aerial vehicle according to claim 1, further comprising a tilt sensor; wherein the controller calibrates the measured distance based on the tilt of the unmanned aerial vehicle.

4. An unmanned aerial vehicle according to claim 1, wherein the first sensor is an ultrasonic transceiver.

5. An unmanned aerial vehicle according to claim 4, wherein the ultrasonic transceiver uses a 100 kHz to 400 Khz frequency.

6. An unmanned aerial vehicle according to claim 4, further comprising: a temperature sensor that calibrates a sonic speed in calculating the first distances.

7. An unmanned aerial vehicle according to claim 1, wherein the second sensor is an infrared transceiver or a microwave transceiver.

8. An unmanned aerial vehicle according to claim 1, further comprising: a gyro sensor that measures the tilt of the vehicle to calibrate the measured distances.

9. A computer-executable method using an unmanned aerial vehicle for measuring a water depth of a field, comprising:
measuring, by a first sensor, a first distance to a water surface;
measuring, by a second sensor, a second distance to a ground; and
calculating, by a controller, a difference between the first distance and the second distance to measure a water depth at a point directly below the unmanned aerial vehicle.

10. A method according to claim 9, wherein water depth measurement is performed during a flight at a predetermined speed or higher.

11. A method according to claim 9, further comprising:
measuring, by a tilt sensor, the tilt of the vehicle; and
calibrating, by the controller, the measured distance based on the tilt of the unmanned aerial vehicle.

12. A method according to claim 9, wherein the first sensor is an ultrasonic transceiver.

13. A method according to claim 12, wherein the ultrasonic transceiver uses a 100 kHz to 400 Khz frequency.

14. A method according to claim 12, further comprising: calibrating, by a temperature sensor, a sonic speed in calculating the first distances.

15. A method according to claim 9, wherein the second sensor is an infrared transceiver or a microwave transceiver.

16. A method according to claim 9, further comprising:
measuring, by a gyro sensor, a tilt of the vehicle;
and calibrating the measured distances based on the tilt of the vehicle.

17. A non-transitory computer readable medium that stores a computer-executable program for measuring a water depth of a field using an unmanned aerial vehicle, comprising instructions for:
measuring, by a first sensor, a first distance to a water surface;
measuring, by a second sensor, a second distance to a ground; and
calculating, by a controller, a difference between the first distance and the second distance to measure a water depth at a point directly below the unmanned aerial vehicle.

18. A non-transitory computer readable medium according to claim 17, wherein water depth measurement is performed during a flight at a predetermined speed or higher.

19. A non-transitory computer readable medium according to claim 17, further comprising instructions for:
measuring, by a tilt sensor, the tilt of the vehicle; and
calibrating, by the controller, the measured distance based on the tilt of the unmanned aerial vehicle.

20. A non-transitory computer readable medium according to claim 17, wherein the first sensor is an ultrasonic transceiver and the second sensor is an infrared transceiver or a microwave transceiver.
